(19) United States
(12) Patent Application Publication
(10) Pub. No.: US 2014/0116346 A1
(43) Pub. Date: May 1, 2014

(54) FRAME FOR AN AQUARIUM

(71) Applicant: Elive LLC, New Berlin, WI (US)

(72) Inventors: Thomas Lutz, Cedar Rapids, IA (US); Matthew Allen, Waterford, WI (US)

(21) Appl. No.: 14/069,477

(22) Filed: Nov. 1, 2013

Related U.S. Application Data
(60) Provisional application No. 61/721,282, filed on Nov. 1, 2012.

(51) Int. Cl. A01K 63/00

(52) U.S. Cl. CPC A01K 63/003
USPC 119/269; 29/428; 29/426.2

(57) ABSTRACT

A containment vessel includes a tank having a front wall, a back walk two side wails, and a base. A top perimeter is defined by a top edge of the front wall, the back wall, and the two side watts and a bottom perimeter is defined by the intersection of each edge of a perimeter of the base and a bottom edge of each of the front wall, the back wall, and the two side walls. An over-frame is coupled to both the top perimeter and the bottom perimeter to at least partially visibly conceal the top perimeter and the bottom perimeter. The over-frame includes an over-frame top portion having a plurality of corner elements and side elements that are coupled together and an over-frame bottom portion having a plurality of corner elements and side elements that are coupled together.

### CROSS REFERENCE TO RELATED APPLICATIONS

This application claims priority to U.S. Provisional Application No. 61/721,282, filed Nov. 1, 2012, the entire contents of which are incorporated herein by reference.

### FIELD OF THE INVENTION

The present invention is directed to a frame for a containment vessel, in particular for an aquarium.

### BACKGROUND

The primary function of an aquarium is to provide a watertight containment vessel for aquatic life with a clear panel or panels for human Observation of the animals and environment. Similarly, a terrarium is a containment vessel for smaller land animals, esp. reptiles, amphibians, or terrestrial invertebrates with a clear panel or panes for human observation of the animals and environment. While an aquarium by definition needs to be watertight, other containment systems may or may not be watertight. These containment vessels are often constructed of glass due to the durability, clarity and construction characteristics of glass. While glass is a preferred vessel material for certain reasons including durability and clarity, vessels constructed of clear plastics (e.g., of such materials as acrylic or styrene) are also utilized due to the benefit of their weight and cost as compared to glass, and because of design limitations inherent with use of glass. These containment vessels range in size from less than one half of a gallon to greater than two hundred gallons for “standard” systems and beyond for custom designs.

The simplest aquarium design consists of 5 panels and an optional cover. There are a front and back panel, two side panels and a bottom to the aquarium. In a standard glass aquarium each panel is adhered to its neighbor through a watertight bonding agent, often silicone, to create a watertight containment vessel. There are more complex designs with curved fronts and backs, different-sized front, back, and side panels, and additional sides.

Similar to glass aquariums, a simple rectangular plastic aquarium can be constructed of 5 panels and an optional top in which the 5 panels are adhered together through a watertight bonding agent. Further, plastic aquariums can be constructed of thermoplastic polymers that are injection moldable. This translates to a single vessel without any seams and a separate, optional cover.

Both glass and plastic aquarium/terrarium containment vessel construction have “failure” limitations (e.g., when water is added to a tank of the aquarium). As water is added, there is an outward pressure on the containment vessel. Depending on the structural integrity of the plastic/glass used, the walls of the containment vessel have the potential to bow under the pressure adding stress to the bonded seams. If this pressure becomes too great there is potential for the aquarium to leak. To balance these stresses a frame is often used to add structural integrity to the tank. Materials used to add structural integrity are often plastic, but could also be made of metal or glass.

There are two purposes of frames, decorative and functional. Functional frames serve a purpose such as adding structural integrity to an aquarium, or provide a base for the aquarium to sit on. Further functional frames serve a purpose in the terrarium environment where an animal may be able to escape by climbing out of the top of the terrarium. In these designs, the function is containment and the frame and optional top panel are connected in a manner to prevent animal escape. The top frame also serves a function of holding a cover, lights, filters and other elements used within an aquarium or terrarium. There is often a channel or ledge integrated into the frame to receive these elements.

The second purpose of a frame is decorative in nature. It should be noted that it is possible to construct a containment vessel without any frame, i.e. frameless, as well. The decorative nature is designed to appeal to the intended end user's preferences. An aquarium that has a frame on its top almost always has a complementary frame on the bottom of the aquarium. The top and bottom frame may both be functional, one of the two might be functional, or both might be decorative in nature.

When a frame is used for functional purposes the designs are often squared off in design and typically constructed of black plastic. As these frames are bonded in some fashion to an aquarium, they are not intended to be removed or replaced by the consumer. If the aesthetic is undesirable to the consumer there are no alternatives to the frame as it conies on the aquarium beyond trying to cover the frame up with the cover and/or aquarium stand and canopy.

Injection molded plastic aquariums typically do not require a frame to prevent “failure” (i.e. water leakage). These aquariums may contort under the pressure of the added water, but will not fail. As such, most frames for injection molded aquariums are press fit onto the aquarium itself and as such are removable by the consumer. The intended purpose of these frames is to prevent and/or hide the contortion due to water pressure and to provide an aesthetically appealing finish to the consumer. Aquariums of this construction are typically small (5 gallons or less). As an aquarium gets above 5 gallons the advantages of injection molding dissipate and as such almost all aquariums are constructed on non-injection molded design of glass with some being made of the multi-panel plastic construction described above.

Five gallons of water weighs approximately 40 pounds. An aquarium that holds 10 gallons of water weighs approximately 80 pounds or more. Decorative frames on small aquariums can be removed, replaced and exchanged easily when the aquarium is full as the overall weight of the aquarium is small enough that the aquarium can be lifted when full of water (e.g., a 2 gallon aquarium weighs approximately 16 pounds). In aquariums 5 gallons and larger this becomes prohibitive due to weight constraints. Further, because the aquarium frames in these aquariums are usually providing functional strength and integrity to the aquarium they cannot be removed. Because it is important to maintain water volume for the life of the fish and other aquatic organisms in the aquarium, and so as to not stress or disturb livestock in a terrarium, it is prohibitive to remove enough water from an aquarium to make the aquarium light enough to move for aquariums larger than 5 gallons. In addition to being logistically prohibitive to move due to weight constraints, it is also undesirable to move, jostle or otherwise disturb an aquarium/terrarium for the health of the livestock.

### SUMMARY

In accordance with one construction, a containment vessel for holding live animals includes a tank having a front wall, a back wall, two side walls, and a base. Atop perimeter is defined by a top edge of the front wall, the back wall, and the two side wails and a bottom perimeter is defined by the intersection of each edge of a perimeter of the base and a bottom edge of each of the front wall, the back wall, and the two side wails. An over-frame is coupled to both the top perimeter and the bottom perimeter to at least partially visibly conceal the top perimeter and the bottom perimeter. The over-frame includes an over-frame top portion having a plurality of corner elements and side elements that are coupled together and an over-frame bottom portion having a plurality of corner elements and side elements that are coupled together.

In accordance with another construction, a method of coupling an over-frame to a containment vessel for holding live animals includes placing a top over-frame side element on the containment vessel, placing a top over-frame corner element on the containment vessel, sliding a male mating component of the top over-frame corner element into a female mating component of the top over-frame side element, placing a bottom over-frame side element on the containment vessel, placing a bottom over-frame corner element on the containment vessel, and sliding a male mating component of the bottom over-frame corner element into a female mating component of the bottom over-frame side element.

In accordance with another construction, a method of coupling an overframe to a containment vessel for holding live animals includes assembling a top over-frame portion by coupling top over-frame corner elements with top over-frame side elements. The method also includes assembling a bottom over-frame portion by coupling bottom over-frame corner elements with bottom over-frame side elements. The method also includes sliding the bottom over-frame portion over the containment vessel, sliding the top over-frame portion over the containment vessel, pushing the top over-frame corner elements and the top over-frame side elements together, and pushing the bottom over-frame corner elements and the bottom over-frame side elements together, until the over-frame fits tightly onto the containment vessel

Other aspects of the invention will become apparent by consideration of the detailed description and accompanying drawings.

### BRIEF DESCRIPTION OF THE DRAWINGS

FIG. 1 is a perspective view of a containment vessel in the form of an aquarium.

FIG. 2 is a perspective view of the containment vessel of FIG. 1, including an over-frame according to one construction of the invention.

FIG. 3 is a schematic cross-sectional view of the containment vessel of FIG. 1, without the over-frame.

FIG. 4 is a schematic cross-sectional of the containment vessel of FIG. 1, with the over-frame.

FIG. 5 is a perspective, disassembled view of various components of a top portion of the over-frame.

FIG. 6 is a perspective view of a corner ea of the top portion of the over-frame.

FIG. 7 is a perspective, disassembled view of various components of a bottom portion of the over-frame.

FIG. 8 is a perspective view of a corner area of the bottom portion of the over-frame.

FIG. 9 is a perspective view of two components of the top portion of the over-frame.

FIG. 10 is a perspective view of two components of the bottom portion of the over-frame.

FIG. 11 is a schematic representation of a kit that includes the over-frame.

FIG. 12 is a schematic cross-sectional view of a containment without a frame.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited.

### DETAILED DESCRIPTION

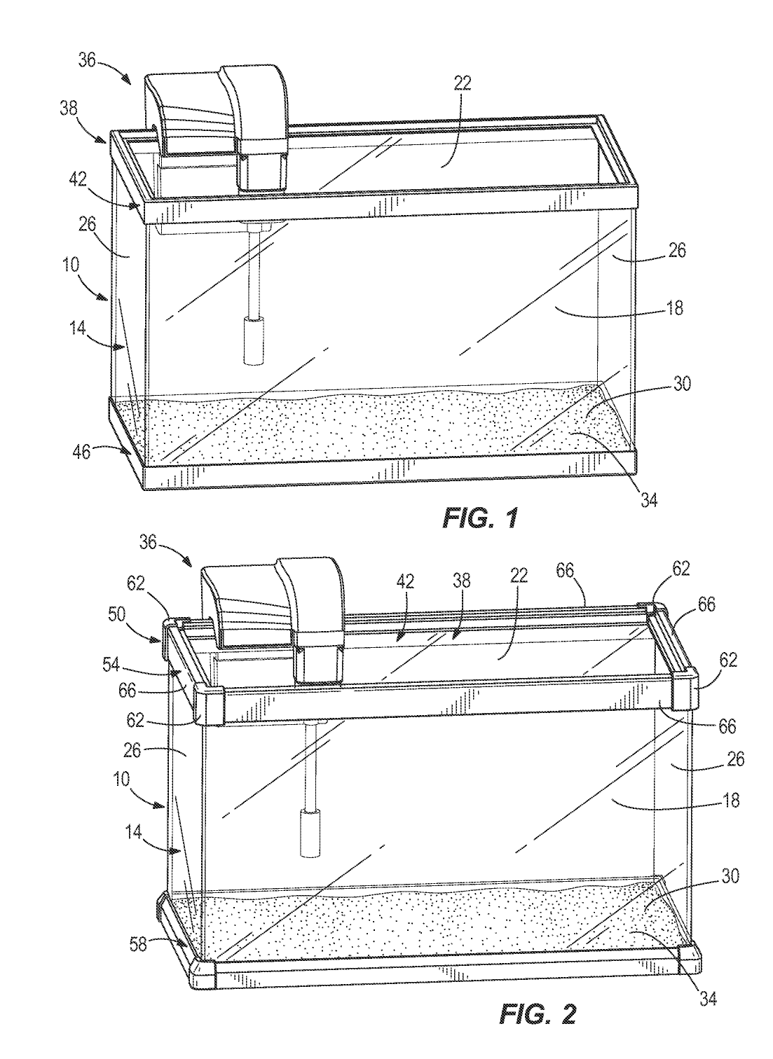

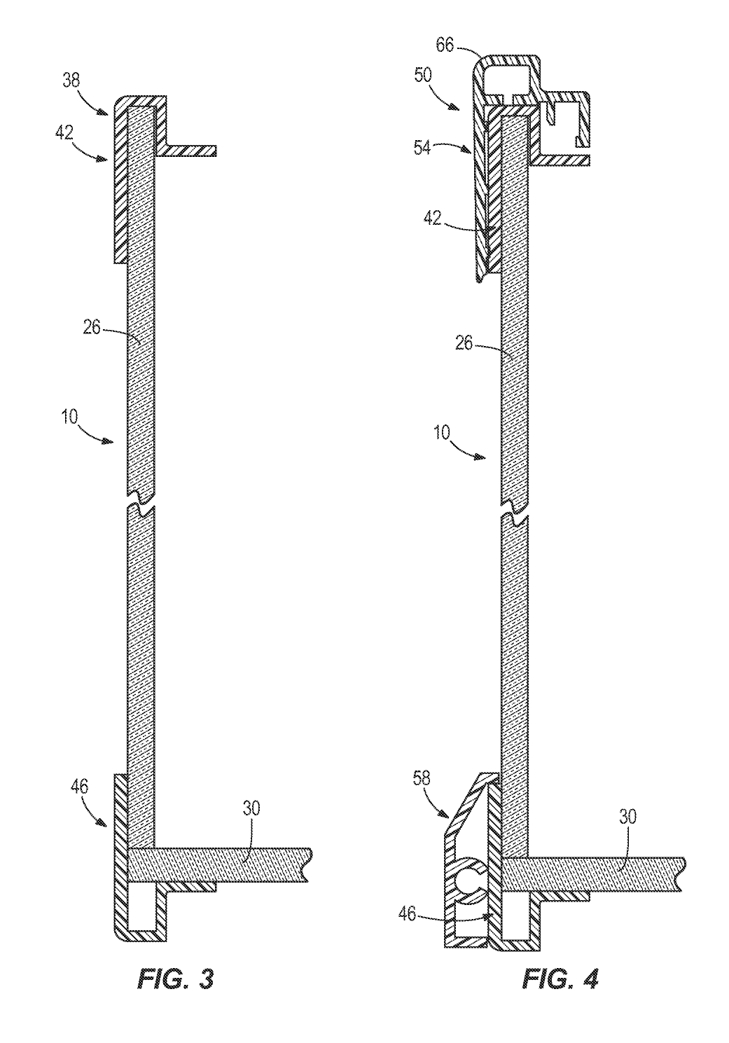

With reference to FIGS. 1-4, a containment vessel 10, in the form of an aquarium, includes a tank 14 for holding water. The tank 14 includes a glass front wall 18, a glass back wall 22, two glass side watts 26, and a glass base 30. In other constructions the walls 18, 22, 26 and the base 30 are plastic or other non-glass material. The base 30 supports a layer of gravel 34 disposed at a bottom of the tank 14. A hang-on filter 36 is coupled to the back wall 22. Though not illustrated, in some constructions the containment vessel 10 also includes lighting elements, heater elements, and decor.

With reference to FIG. 1, the containment vessel 10 includes a frame 38 having a top frame portion 42 and a bottom frame portion 46. The top frame portion 42 and the bottom frame portion 46 are chemically bonded to the containment vessel 10 and are intended not to be removed from the containment vessel 10. In the illustrated construction, the top frame portion 42 and the bottom frame portion 46 are bonded to the glass walls 18, 22, 26 and base 30 to give structural integrity to the containment vessel 10. In some constructions the thickness and construction of the glass (or plastic) is substantial enough to not require a frame 38 for structural purposes.

With reference to FIGS. 2 and 4, the containment vessel 10 includes an over-frame 50. The over-frame 50 includes a top over-frame portion 54 and a bottom over-frame portion 58. The top over-frame portion 54 completely covers the top frame portion 42 of the containment vessel 10. The top over-frame portion 54 contains similar structural elements to the top frame portion 42 so as to maintain functional consistency with the original frame portion 42 or in the case where the containment vessel 10 is frameless, to provide a structural element for lights, filters, covers, etc. to be utilized. The bottom frame portion 46 is similarly covered by the bottom over-frame portion 58. Both the top over-frame portion 54 and the bottom over-frame portion 58 have design detail to completely cover the top frame portion 42 and the bottom frame portion 42 in a manner that it appears that the over-frame portions 54, 58 are integrated into the containment vessel 10.

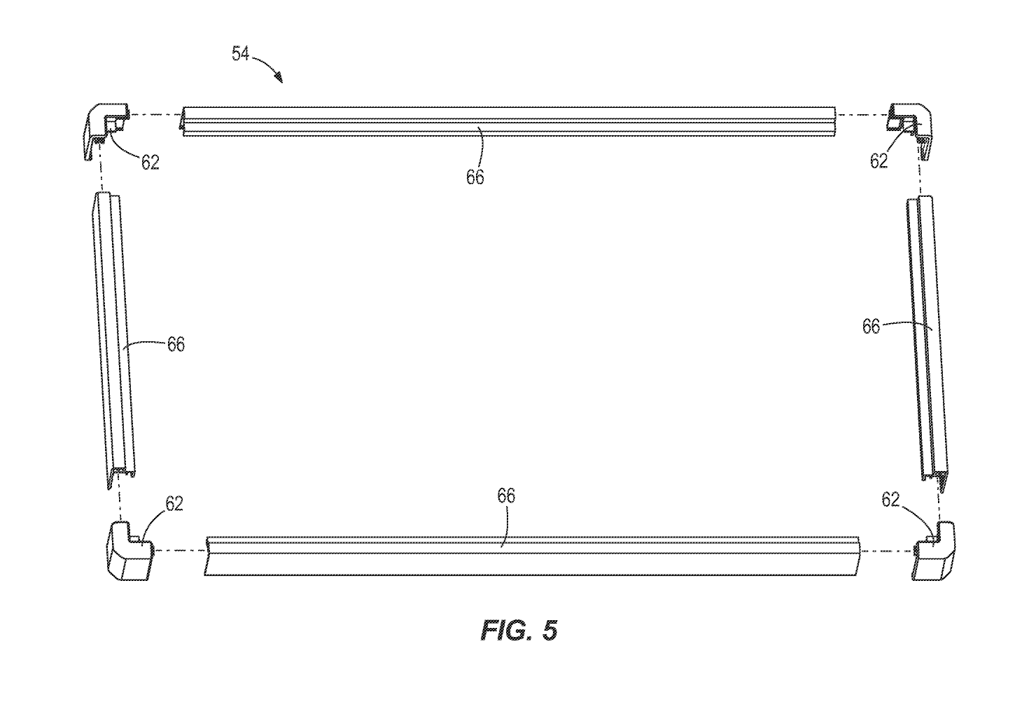

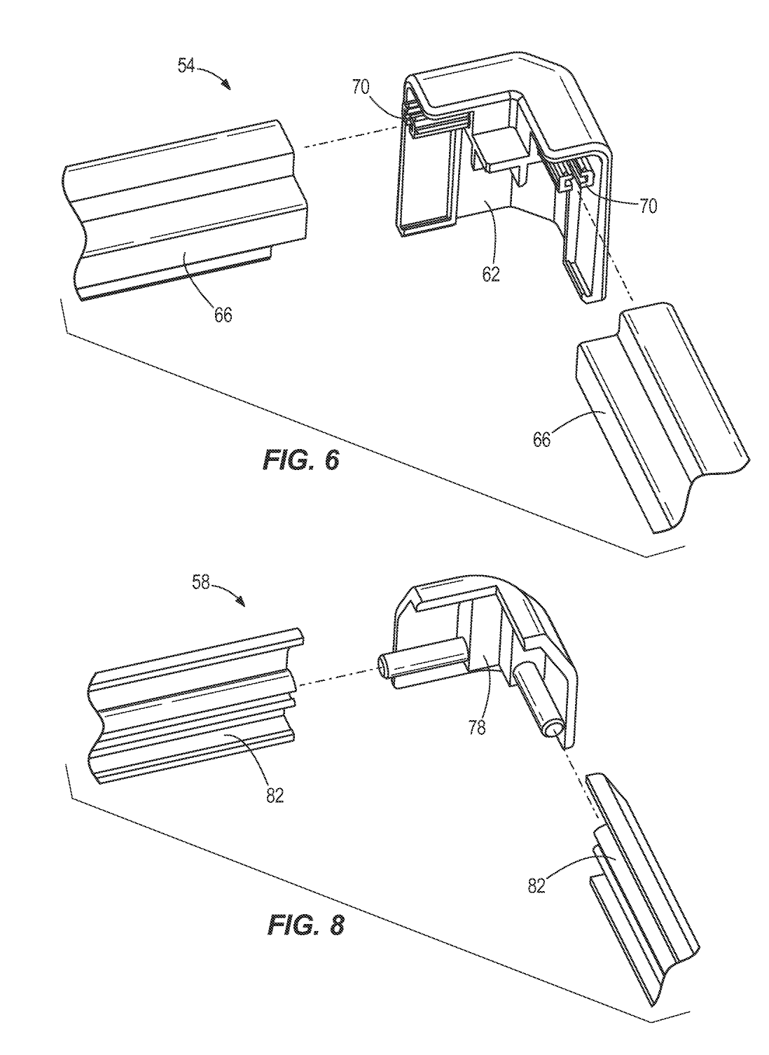

With reference to FIGS. 5 and 6, the top over-frame portion 54 includes four corner elements 62 and four side elements 66. Each of the corner elements 62 is respectively the same, and each of the side elements 66 is respectively the same. In some constructions each corner element 62 has its own independent design/construction. In some constructions each side element 66 has its own design/construction.

With reference to FIGS. 1-6, the corner elements 62 are movable (e.g., in contrast to a static frame), which provides an ability to install the top over- frame portion 54 without having to move the containment vessel 10. This serves multiple functions. For example, it allows for the top over-frame portion 54 to be installed on containment vessels 10 of slightly different size (e.g., duo to different manufacturers, different designs, and different molds) as well as enables a user to install the top over-frame portion 54 without having to move or otherwise empty the water and livestock out of the containment vessel 10. The moveable corner elements 62 are independent pieces in illustrated construction, although in other constructions the corner elements 62 may be adjustable elements of the top over-frame portion 54 itself that enable for the aforementioned functions.

With reference to FIGS. 6 and 9, each corner element 62 has at least one male component 70 that slides into a female component 74 on one of the side elements 66. The male component 70 is a rectangular pin, and the female component 74 is a rectangular aperture sized to receive the rectangular pin. Other constructions include square pins and apertures, circular or oval pins and apertures, hooks, or other structures for the male and female mating components 70, 74. The construction and the design of the corner elements 62 and side elements 66 may be inversed or constructed of a variety of patterns, but the functional utility is such that a user is able to create a tight fit of the entire top over-frame portion 54 onto the top frame portion 42 without having to move the containment vessel 10. Once all four top over-frame side elements 66 and top over-frame corner elements 62 are in place, the elements are tightened (e.g., by pushing/pulling the male components 70 tight into the female components 74 on all corner elements 62 and side elements 66). The end result is a tight-fitting top over-frame portion 54 that fully covers the bonded top frame portion 42 or exposed glass edge of a frameless containment vessel 10.

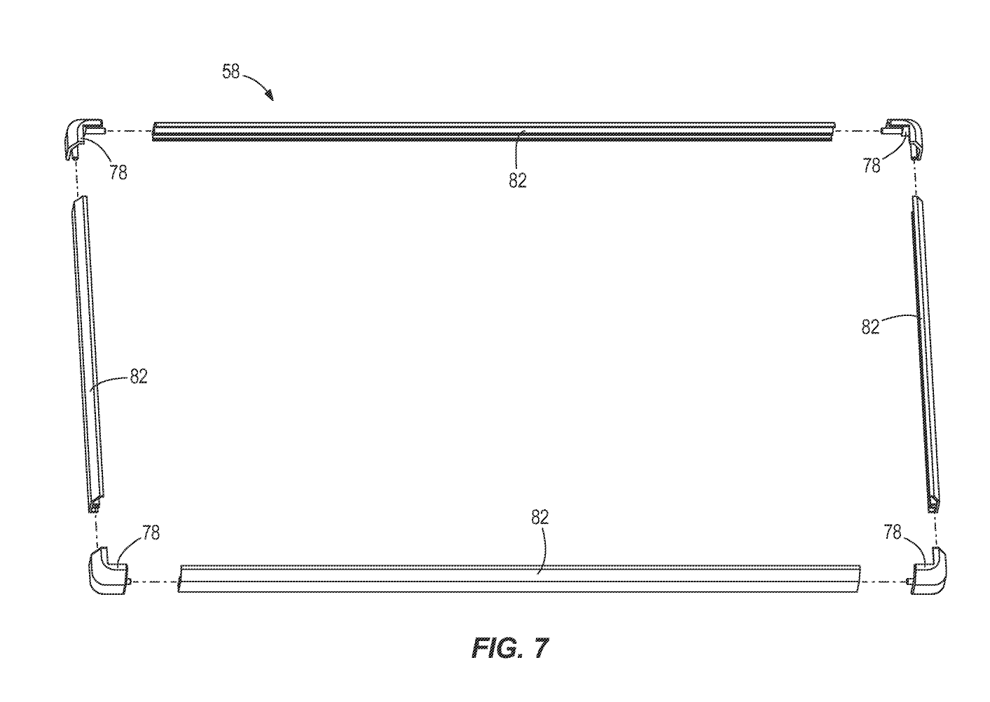

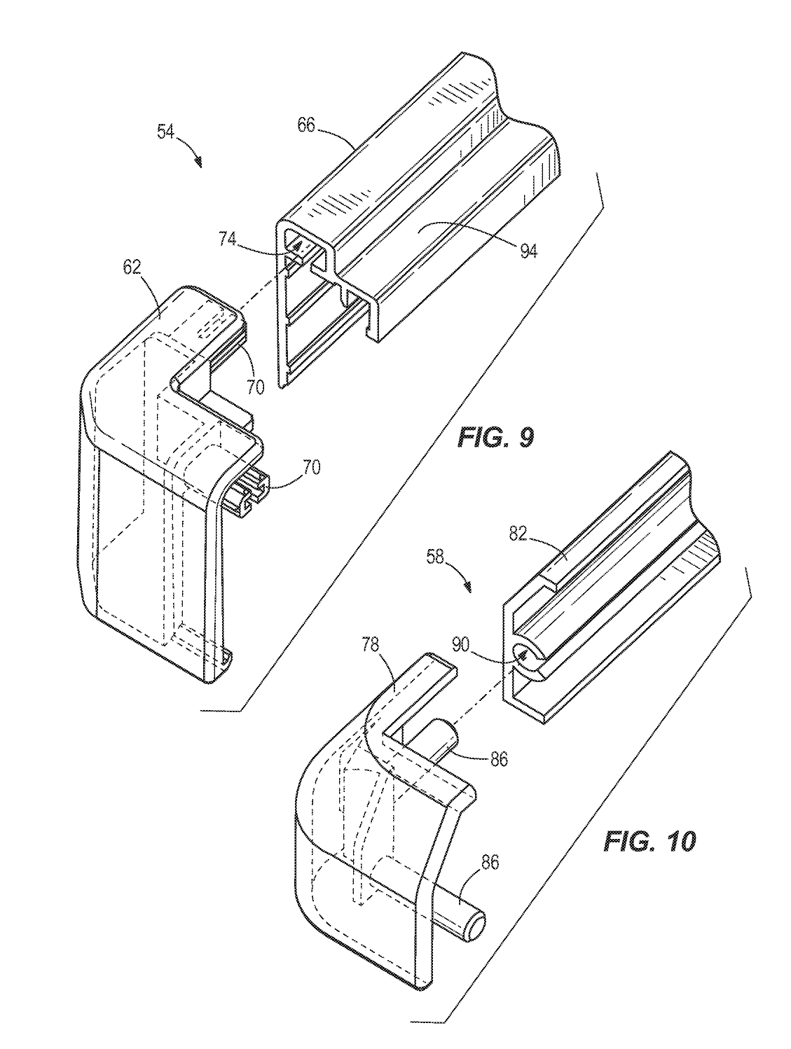

With reference to FIGS. 7 and 8, the bottom over-frame portion 58 includes four corner elements 78 and four side elements 82. Each of the corner elements 78 are respectively the same, and each of the side elements 82 are respectively the same. In some constructions each corner element 78 has its own independent design/construction. In some constructions each side element 82 has its own design/construction.

With reference to FIGS. 1-8, the corner elements 78 are movable (in contrast to a static frame), which provides an ability to install the bottom over-frame 58 without having to move the containment vessel 10. This serves multiple functions. For example, it allows for the bottom over-frame portion 58 to be installed on containment vessels 10 of slightly different size (e.g., due to different manufacturers, different designs, and different molds) as well as enables a user to install the bottom over-frame portion 58 without having to move or otherwise empty the water and livestock out of the containment vessel 10. The moveable corner elements 78 are independent pieces in the illustrated construction, although in other constructions the corner elements 78 may be adjustable elements of the bottom over-frame portion 58 itself that enable for the aforementioned functions.

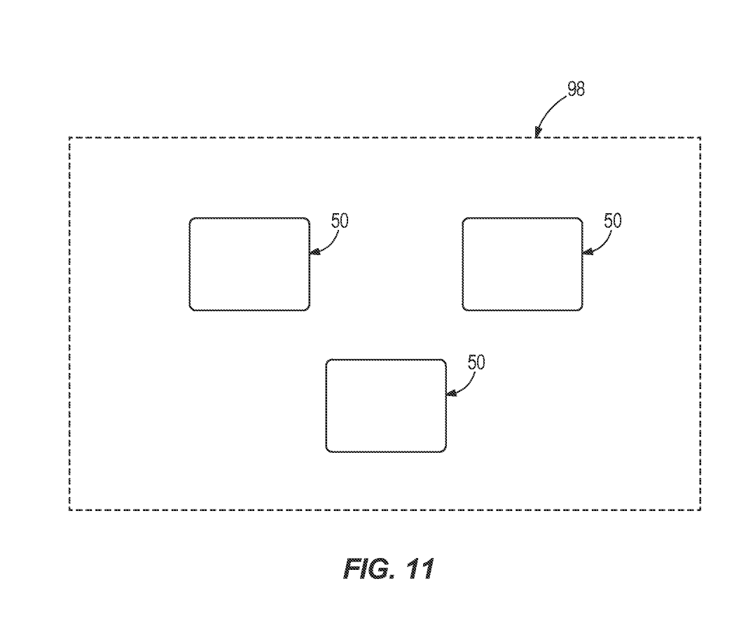

With reference to FIG. 10 each corner element 78 has a male component 86 that slides into a female component 90 on one of the side elements 82. The male component 86 is a circular pin, and the female component 90 is a circular aperture sized to receive the circular pin. Other constructions include square pins and apertures, rectangular pins and apertures, hooks, or other structures for the male and female mating components 86, 90. The construction and the design of the corner elements 78 and side elements 82 may be inversed or constructed of a variety of patterns, but the functional utility is such that a user is able to create a tight fit of the entire bottom over-frame portion 58 onto the bottom frame portion 46 without having to move the containment vessel 10. Once all four bottom over-frame side elements 82 and bottom over-frame corner elements 78 are in place, the elements are tightened (e.g., by pushing/pulling the male components 86 tight into the female components 90 on all corner elements 78 and side elements 82). The end result is a tight-fitting bottom over-frame portion 58 that full covers the bonded bottom frame portion 46 or exposed glass edge of a frameless containment vessel 10.

With continued reference to FIGS. 9 and 10, the design and functionality of the bottom over-frame portion 58 is different from the top over-frame portion 54. For example, as illustrated in FIG. 9, the top over-frame portion 54 has a structural element 94 such as a ledge or tip on at least one of the side elements 66 that enables components such as filters, aquarium covers and lighting to be installed on the containment vessel 10. The element 94 is undesirable on the bottom over-frame portion 58 as its presence there would require the containment vessel 10 to be lifted or moved for full installation. For this reason, the structures for the top over-frame portion 54 and bottom over-frame portion 58 are different. However, in sonic constructions the structural element 94 may be removed, such that the top over-frame portion 54 and the bottom over-frame portion 58 have the same profiles.

Installation of the over-frame 50 without emptying or moving the containment vessel 10 may be accomplished, for example, as follows:

(1) Remove any elements that are on the top of the containment vessel 10 that would encumber the installation of the top over-frame portion 54. This would include elements such as the filter 36, aquarium covers, lights, etc. Air tubing and electrical cables running to elements in the containment vessel 10 do not need to be removed, only those elements on the containment vessel 10.

(2) Place the top over-frame side element 66 on the containment vessel 10. If air tubing or electrical cables remain, place the side element 66 underneath these components prior to installing the side element 66 onto an edge of the containment vessel 10.

(3) Place a top over-frame corner element 62 onto the containment vessel 10.

(4) Slide the male component 70 and the female component 74 from the top over-frame corner 62 and the side element 66, respectively, into each other.

(5) Work around the containment vessel 10 and push all corner elements 62 and side elements 66 together until the top over-frame 54 fits tightly onto the containment vessel 10.

(6) Re-install all elements removed in step (1).

(7) Install the bottom over-frame portion 58 by first placing a bottom over-frame side element 82 into place.

(8) Place the bottom over-frame corner element 78 onto the containment vessel 10.

(9) Slide the male component 86 and the female component 90 from the bottom over-frame corner element 78 and side element 82, respectively, into each other.

(10) Work around the containment vessel 10 and push all corner elements 78 and side elements 82 together until the bottom over-frame portion 58 fits tightly onto the containment vessel 10.

(11) Installation is complete and the containment vessel 10 did not have to he moved, nor did any water have to be removed from the containment vessel 10.

Installation of the over-frame 50 without emptying or moving the containment vessel 10 may alternatively be accomplished as follows:

(1) Remove all elements that are on the top of the containment vessel 10 that would encumber the installation of the top over-frame portion 54. This would include elements such as the filter 36, aquarium covers, lights, etc. Air tubing and electrical cables running to elements in the aquarium should also be removed.

(2) Assemble the bottom over-frame portion 58 and the top over-frame portion 54, leaving the side elements 66, 82 extended out as far as possible. In a construction in which the corner elements 62, 78 and the side elements 66, 82 are not separate elements, leave the over-frame 50 extended in its “largest” configuration.

(3) Assemble the bottom over-frame portion 58 by inserting the male components 70 from the corner elements 62 into the female components 74 of the side elements 66.

(4) Assemble the top over-frame portion 58 by inserting the male components 86 from the corner elements 78 into the female components 90 of the side elements 82.

(5) Slide the fully assembled bottom over-frame portion 58 over the containment vessel 10.

(6) Slide the fully assembled top over-frame portion 54 onto the top of the containment vessel 10.

(7) Work around the containment vessel 10 and push all the top corner elements 62 and side elements 66 and bottom corner elements 78 and side elements 82 together until the over-frame 50 fits tightly onto the containment vessel 10.

(8) Re-install all elements removed in step (1).

(9) Installation is complete and the containment vessel 10 did not have to he moved, nor did any water have to be removed from the containment vessel 10.

The over-frame 50 described above may be used in any environment in which installation of an over-frame 50 is desired, and where moving a containment vessel 10 is prohibitive due to weight of the containment vessel 10, fear of stress on an animal in the containment vessel 10, or any other reason. While the containment vessel 10 has been described in the context of an aquarium, in other constructions the containment vessel 10 is a reptile enclosure, a turtle tank, a rabbit cage, a hamster cage, a bird cage, or other type of containment vessel.

The over-frame 50 may be used as an after-market animal habitat frame that can be easily installed by a consumer for decorative and/or functional purposes. The over-frame 50 may be coupled to permanent frames, to frameless aquariums, to small aquariums, and other structures. While the illustrated over-frame 50 has been described and illustrated as having a generally rectangular structure, in other constructions the over-frame 50 has other shapes and sizes than that illustrated.

As aquariums and other containment vessels can become very heavy, the over-frame 50 enables a consumer to install, replace, and/or change the over-frame 50 without moving the containment vessel 10. The over-frame 50 also enables existing covers, filters, lights and other elements to continue to be used on a containment vessel 10 after installation of the over-frame 50. The over-frame 50 may be decorative in nature so that a consumer can change the external look of the containment vessel 10, but may also include additional functional elements, such as integrated filtration, lighting, air tubing, in-tank decor, etc. The over-frame 50 maintains the functional utility of an integrated frame, or top edge of a frameless aquarium, in being able to support hang-on aquarium filters, tank covers, lighting, etc.

Additionally, by placing the over-frame 50 on a plurality of visually distinct aquariums or other containment vessels 10, the containment vessels 10 may become more visually uniform, thereby improving the aesthetic appeal of the containment vessels 10. In some constructions, and with reference to FIG. 11, the over-frame 50 may be provided as a kit 98. The kit 98 may include one or more over-frames 50 that can be coupled to a component of an existing containment vessel 10.

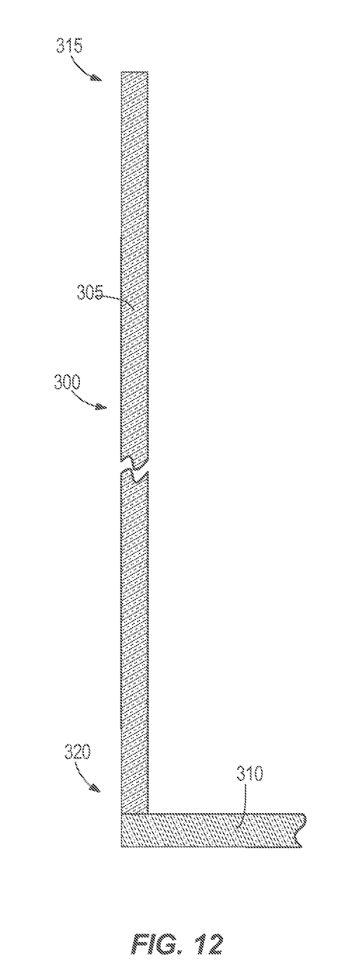

It should be noted that while the invention has been described as being attached to an aquarium including a permanent top frame and a permanent bottom frame, other constructions can be applied to frameless aquariums 300 as illustrated in FIG. 12. The frameless aquarium includes a front wall 305, a rear wall, two side walls and a base 310 like the framed aquarium. The front wall 305, the rear wall, and the two side walls each include top edges that cooperate to define a top perimeter 315, The base 310 includes a perimeter defined by the outer edges of the base 310. The outer edges cooperate with the bottom edges of the front wall 305, the rear wall, and the two side walls to define o bottom perimeter 320. In aquariums with frames, the top frame is positioned around the top perimeter and the bottom frame is positioned around the bottom perimeter. In frameless aquariums, there is no frame and the invention described herein is positioned around the top perimeter 315 and the bottom perimeter 320.

Although the invention has been described in detail with reference to certain preferred embodiments, variations and modifications exist within the scope and spirit of one or more independent aspects of the invention as described.

1. A containment vessel for holding live animals comprising:
a tank having a front wall, a back wall, two side walls, and a base;
a top perimeter defined by a top edge of the front wall, the back wall, and the two side watts;
a bottom perimeter defined by the intersection of each edge of a perimeter of the base and a bottom edge of each of the front wall, the back wall, and the two side walls; and
an over-frame coupled to both the top perimeter and the bottom perimeter to at least partially visibly conceal the top perimeter and the bottom perimeter, the over-frame including:
an over-frame top portion having a plurality of corner elements and side elements that are coupled together; and
an over-frame bottom portion having a plurality of corner elements and side elements that are coupled together.

2. The containment vessel of claim 1, wherein the over-frame top portion includes four corner elements and four side elements.

3. The containment vessel of claim 1, wherein the over-frame bottom portion includes four corner elements and four side elements.

4. The containment vessel of claim 1, wherein the corner elements includes a male mating component.

5. The containment vessel of claim 4, wherein the male component includes a circular pin,

6. The containment vessel of claim 1, wherein the side elements include a female mating component.

7. The containment vessel of claim 6, wherein the female component includes a circular aperture sized to receive a circular pin.

8. The containment vessel of claim 1, wherein the containment vessel is a glass aquarium.

9. The containment vessel of claim 1, further comprising a top frame portion permanently bonded to the tank around the top perimeter and a bottom frame portion permanently bonded to the tank around the bottom perimeter.

10. The containment vessel of claim 9, wherein the top over-frame portion completely covers the top frame portion.

11. The containment vessel of claim 1, wherein the top over-frame portion includes a ledge configured to support on of a filter, an aquarium cover, and lighting, and wherein the bottom over-frame portion does not include a ledge.

12. A method of coupling an over-frame to a containment vessel for holding live animals, the containment vessel including a front wall, a back wall, two side walls, and a base, the method comprising:
placing a top over-frame side element on the containment vessel;
placing a top over-frame corner element on the containment vessel;
sliding a male mating component of the top over-frame corner element into a female mating component of the top over-frame side element;
placing a bottom over-frame side element on the containment vessel;
placing a bottom over-frame corner element on the containment vessel; and
sliding a male mating component of the bottom over-frame corner element into a female mating component of the bottom over-frame side element.

13. The method of claim 12, further comprising coupling a plurality of top over-frame side elements to a plurality of top over-frame corner elements.

14. The method of claim 12, further comprising coupling a plurality of bottom over-frame side elements to a plurality of bottom over-frame corner elements.

15. The method of claim 12, further comprising removing an element from the containment vessel prior to placing the top over-frame side element, top over-frame corner element, bottom over-frame side element, and bottom over-frame corner element onto the containment vessel.

16. The method of claim 15, wherein the over-frame is coupled to the containment vessel without moving the containment vessel, and without removing any water from the containment vessel.

17. A method of coupling an over-frame to a containment vessel for holding live animals, the containment vessel including a front wall, a back wall, two side walls, and a base, the method comprising:
assembling atop over-frame portion by coupling top over-frame corner elements with top over-frame side elements;
assembling a bottom over-frame portion by coupling bottom over-frame corner elements with bottom over-frame side elements;
sliding the bottom over-frame portion over the containment vessel;
sliding the top over-frame portion over the containment vessel;
pushing the top over-frame corner elements and the top over-frame side elements together; and
pushing the bottom over-frame corner elements and the bottom over-frame side elements together, until the over-frame fits tightly onto the containment vessel.

18. The method of claim 17, further comprising removing an element from the containment vessel prior to sliding the bottom over-frame portion and the top over-frame portion over the containment vessel.

19. The method of claim 18, wherein the step of removing an element includes removing an aquarium filter.

20. The method of claim 17, wherein the over-frame is coupled to the containment vessel without moving the containment vessel, and without removing any water from the containment vessel.
